(19) United States
(12) Patent Application Publication
(10) Pub. No.: US 2014/0178787 A1
(43) Pub. Date: Jun. 26, 2014

(54) SOLID OXIDE FUEL CELL ASSEMBLY AND METHOD FOR FORMING SEAL

(71) Applicant: SAMSUNG ELECTRO-MECHANICS CO., LTD., Suwon (KR)

(72) Inventors: Jong Ho Chung, Suwon (KR); Sung Han Kim, Suwon (KR); Jong Sik Yoon, Suwon (KR); Bon Seok Koo, Suwon (KR)

(73) Assignee: SAMSUNG ELECTRO-MECHANICS CO., LTD., Suwon (KR)

(21) Appl. No.: 13/831,623

(22) Filed: Mar. 15, 2013

(30) Foreign Application Priority Data
Dec. 21, 2012 (KR) 10-2012-0150565

(51) Int. Cl. H01M 8/02

(52) U.S. Cl. CPC H01M 8/0276; H01M 8/0286
USPC 429/465; 429/535

(57) ABSTRACT

Disclosed herein is a solid oxide fuel cell assembly, including: one or more unit cell, a box-shaped housing provided in the unit cell so as to prevent fuel and air from contacting with each other; a metal plate provided with one or more penetration hole in a plate shape partitioning the housing so as to prevent fuel and air from contacting with each other; and a seal sealing a spaced gap between an outer circumferential surface of the unit cell and a penetration hole of a metal plate. The preferred embodiment of the present invention provides the reliable sealed state between the unit cell and the metal plate by using the seal formed of a sealant, a bonding material, and a sealing material.

### CROSS REFERENCE TO RELATED APPLICATION

This application claims the benefit of Korean Patent Application No. 10-2012-0150565, filed on Dec. 21, 2012, entitled “Solid Oxide Fuel Cell Assembly and Method for Forming Seal” which is hereby incorporated by reference in its entirety into this application.

### BACKGROUND OF THE INVENTION

1. Technical Field

The present invention relates to a solid oxide fuel cell assembly and a method for forming a seal.

2. Description of the Related Art

Generally, a fuel cell is an apparatus that directly converts fuel (hydrogen, LNG, LPG, and the like) and chemical energy of air (oxygen) into electricity and heat by an electrochemical reaction. Power generation technologies according to the prior art include processes such as fuel combustion, evaporation generation, turbine driving, generator driving, and the like, but a fuel cell does not include the processes of fuel cell or turbine driving, therefore, the fuel cell is a power generation technology of a new concept which may increase power generation efficiency and does not lead to environmental problems. The fuel cell may little emit air pollutant such as SOX, NOX, and the like, and little generates dioxide carbon to implement pollution-free power generation and has advantages of low noise, no-vibration, and the like.

The fuel cell may include various types such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), and the like. Among others, the solid oxide fuel cell (SOFC) has low overvoltage and a small irreversible loss based on activation polarization, thereby increasing the power generation efficiency. In addition, as the reaction speed is rapid in an electrode, the solid oxide fuel cell (SOFC) does not need not expensive precious metals as an electrode catalyst. Therefore, the SOFC is a power generation technology that is essential to enter hydrogen economy in the future.

Unlike the existing polymer electrolyte membrane fuel cell (PEMFC), the characteristics of the solid oxide fuel cell have a high freedom in selection of fuel as it can use any of the carbon or hydrocarbon-based fuels. Meanwhile, when hydrogen H₂ is used as fuel, the chemical reaction formula is represented as follows.

H₂(g)+O²⁻→H₂O(g)+2e⁻CO(g)+O²⁻→CO₂(g)+2e⁻ Anode Reaction

O₂(g)+4e- →2O²⁻ Cathode Reaction

O₂+H₂+CO→H₂O+CO₂ Overall Reaction

The existing solid oxide fuel cell assembly stacks a plurality of unit cells in a serial and/or parallel type based on the foregoing chemical reaction to generate electric energy. In this case, the unit cells are inserted into through holes of a metal plate used within the solid oxide fuel cell assembly and is fixed.

For example, Korean Patent Laid-Open Publication No. 10-2004-0103422 (Patent Document 1) discloses various types of bonding methods such as a welding method, a screwing method, a fitting method, and the like, to bond a conductive metal plate with a unit cell. However, in the structure of the solid oxide fuel cell assembly, a bonded part between the metal plate and the unit cell is exposed to the high-temperature power generation temperature to melt a sealing material applied to the bonded part and make the sealed state between the metal plate and the unit cell incomplete, such that durability may be deteriorated.

### PRIOR ART DOCUMENT

### Patent Document

(Patent Document 1) Patent Document 1: Korean Patent Laid-Open Publication No. 10-2004-0103422

### SUMMARY OF THE INVENTION

The present invention has been made in an effort to improve a sealed state between metal plates and a plurality of unit cells to be inserted between the metal plates, within a solid oxide fuel cell assembly.

According to a preferred embodiment of the present invention, there is provided a solid oxide fuel cell assembly including a seal formed between a unit cell and a metal plate, the solid oxide fuel cell including: one or more unit cell, a box-shaped housing provided in the unit cell so as to prevent fuel and air from contacting with each other; a metal plate provided with one or more penetration hole in a plate shape partitioning the housing so as to prevent fuel and air from contacting with each other; and a seal sealing a spaced gap between an outer circumferential surface of the unit cell and a penetration hole of a metal plate.

The sealant may have a plate shape having a through hole. Preferably, the through hole of the sealant may be formed to correspond to an arrangement position of the penetration hole to help the stacking of the unit cell.

The bonding material may be applied between an edge of the through hole of the sealant and an outer circumferential surface of the unit cell.

The bonding material may be a medium certainly fixing while sealing between the sealant and the unit cell.

The sealing material may be applied to cover an outer circumferential surface of the bonding material. The sealing material may be applied between an upper surface of the sealant and the outer circumferential surface of the unit cell.

Preferably, the sealant may be formed of a mica material for conduction prevention, workability, and oxidation prevention.

The bonding material may be formed of a porous ceramic-based bond so as to sufficiently allow thermal expansion and shrinkage.

For reference, the sealant may be formed of a glass-based material.

In addition, the sealant may have an O-ring shape instead of a plate shape and may be arranged along the outer circumferential surface of the unit cell and an edge of the penetration hole of the metal plate.

According to another preferred embodiment of the present invention, there is provided a method for forming a seal in a solid oxide fuel cell assembly, the method including: supplying a sealant; seating the sealant on a metal plate; applying a bonding material to a through hole of the sealant; and applying the sealing material on the bonding material.

The method for forming a solid oxide fuel cell assembly may further include: heat treating.

In the heat treating, heat treatment may be performed at 100° C. to 200° C. so as to affect the bonding material. In the heat treating, heat treatment may be performed at 700° C. to 900° C. so as to affect the sealing material.

The sealant may be prepared of a mica material for conduction prevention, workability, and oxidation prevention.

The bonding material may be formed of a porous ceramic-based bond so as to sufficiently allow thermal expansion and shrinkage.

The sealant may have a plate shape having a through hole corresponding to the metal plate and may be arranged on a metal plate.

The bonding material may be applied between an edge of the through hole of the sealant and an outer circumferential surface of the unit cell.

The sealing material may be applied to cover an outer circumferential surface of the bonding material. In particularly, the sealing material may be applied between an upper surface of the sealant and the outer circumferential surface of the unit cell.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating a solid oxide fuel cell assembly according to a preferred embodiment of the present invention;

FIG. 2 is a transverse cross-sectional view of the solid oxide fuel cell assembly of FIG. 1 taken along the line II-II;

FIG. 3 is a partial enlarged view of arc portion ‘A’ of FIG. 1; and

FIG. 4 is a flow chart sequentially illustrating a process of forming a sealing material in the solid oxide fuel cell assembly according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

Hereinafter, a solid oxide fuel cell assembly according to the present invention will be described with reference to the accompanying drawings.

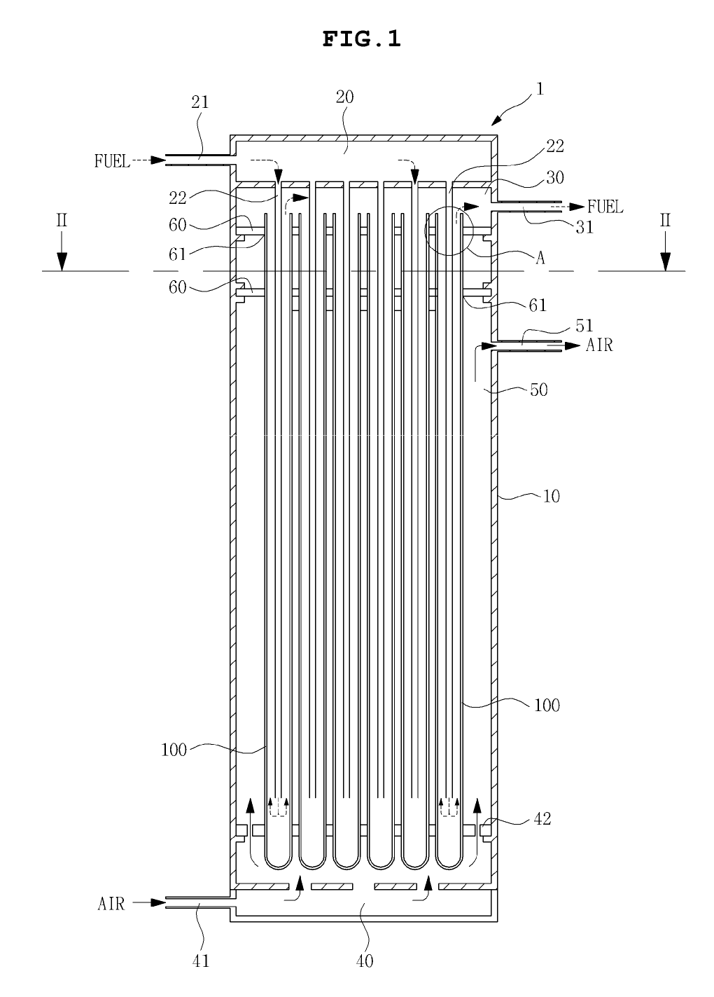

FIG. 1 is a diagram schematically illustrating a solid oxide fuel cell assembly according to a preferred embodiment of the present invention.

Referring to the drawings, in a solid oxide fuel cell assembly 1 according to a preferred embodiment of the present invention, unit cells 100 widely known are arranged in a box-shaped housing 10 in a stacked state via metal plates 60. As the unit cell 100, a cylindrical or flat tubular unit cell that can be adopted for the solid oxide fuel cell may be used and the unit cell 100 are stacked in an order of an internal electrode, an electrolyte, and an external electrode from a center as being widely known to those skilled in the art. As an example, the unit cell 100 may be stacked in an order of an anode (internal electrode), an electrolyte, and a cathode (external electrode) or as another example, the unit cell 100 may be stacked in an order of a cathode (internal electrode), an electrolyte, and an anode (external electrode).

The present specification will mainly describe the solid oxide fuel cell assembly 1 adopting the unit cell 100 using the anode as the internal electrode. Further, unlike the present embodiment, when the unit cell 100 using the cathode as the internal electrode is adopted, it is revealed beforehand that the unit cell 100 in which only a configuration of a moving path of fuel and air is substituted may be used.

A housing 10 includes a fuel supply portion 20 and a fuel discharge portion 30. In detail, fuel supplied to the fuel supply portion 20 through a fuel supply pipe 21 is guided to the unit cell 100 along a plurality of channel pipes 22. Then, fuel has oxidation reaction with the unit cell 100 and the remaining fuel is discharged to a fuel discharge pipe 31 passing through the fuel discharge portion 30.

In order to implement the process, as illustrated, according to the preferred embodiment of the present invention, the fuel supply portion 20 and the fuel discharge portion 30 are disposed on an upper part of an inner space of the housing 10. Further, the fuel supply portion 20 is provided to be fluid communicable with the plurality of channel pipes 22 to supply fuel into each unit cell 100.

As illustrated, an upper part of the unit cell 100 is fluid communicable with the fuel discharge unit 30 to guide fuel crossing the unit cell 100 to the fuel discharge portion 30.

Further, the housing 10 has an air supply portion 40 disposed at a lower portion of the inner space thereof, and air introduced through the air supply pipe 41 from the outside is supplied to the air discharge portion 50 through the air supply portion 40 and a distribution plate 42. The distribution plate 42 has a plate shape provided with a plurality of through holes or may also be a plate formed of porous materials. The distribution plate 42 may be provided to uniformly diffuse and supply air to the air discharge portion 50.

The air supplied to the air discharge portion 50 contacts the external electrode of the unit cell 100 to lead to a reduction reaction. The remaining air is discharged to the outside through the air discharge pipe 51.

In order to implement the process, according to the preferred embodiment of the present invention, the air supply portion 40 is disposed to be mutually fluid communicable with the air discharge portion 50 and the distribution plate 42 may be additionally arranged between the air supply portion 40 and the air discharge portion 50.

In particular, according to the preferred embodiment of the present invention, the metal plate 60 is arranged between the fuel discharge portion 30 and the air discharge portion 50 so as to prevent air and fuel from contacting each other within the housing 10. The metal plate 60 is a component to mutually seal the fuel discharge portion 30 and the air discharge portion 50 while partitioning the fuel discharge portion 30 and the air discharge portion 50 and is provided with a plurality of penetration holes 61. As illustrated in FIGS. 1 and/or 2, the unit cells 100 are inserted into the penetration holes 61 of the metal plate 60 and are fixed within the housing 10.

In addition, the metal plate 60 needs to continuously maintain a sealed state under the high-temperature environment while certainly sealing a spaced gap between the penetration hole 61 and the unit cell 100. If the solid oxide fuel cell assembly 1 contacts fuel and air within the high-temperature housing 10, an intense oxidation reaction and/or an explosion may be caused. Therefore, in order to realize the certain block of fuel and air, as described above, the metal plate 60 seals the housing 10 while certainly partitioning the housing 10.

To this end, according to the preferred embodiment of the present invention, a unique seal 200 of the preferred embodiment of the present invention is disposed in a spaced gap between the penetration hole 61 of the metal plate 60 and an outer circumferential surface of the unit cell 100. The seal 200 formed in the solid oxide fuel cell assembly 1 according to the preferred embodiment of the present invention will be described in more detail with reference to FIG. 3.

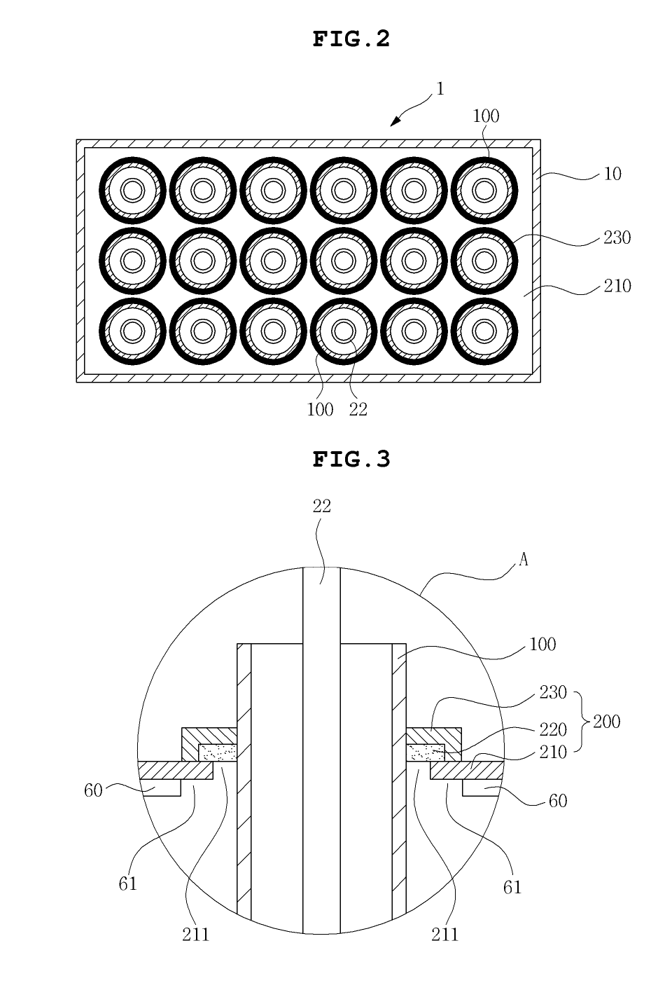

As illustrated in FIGS. 2 and 3, according to the preferred embodiment of the present invention, the penetration hole 61 of the metal plate 60 is provided with the unit cell 100. The seal 200 so as to certainly fix the unit cell 100 in the penetration hole 61 and seal the spaced gap therebetween is formed along the outer circumferential surface of the unit cell 100.

The seal 200 is configured of a sealant 210, a bonding material 220, and a sealing material 230. The sealant 210 is arranged on the metal plate 60 so as to narrow the spaced gap formed between the penetration hole 61 of the metal plate 60 and the outer circumferential surface of the unit cell 100, thereby securing sealability (or air tightness) but may be preferably formed of a mica material securing heat resistance and insulation so as not to be electrically connected with the metal plate 60 while providing the durability under the same high temperature as power generation temperature.

In particular, the sealant 210 is formed in a plate shape and the plate is provided with a plurality of through holes 211. As illustrated, the sealant 210 is formed in a plate shape completely covering the upper surface of the metal plate 60 and blocks fuel and air from contacting with each other, thereby preventing the oxidation of the metal plate 60.

Preferably, the through hole 211 of the sealant 210 is provided to have the same number and the same arrangement position as the penetration holes 61 of the metal plate 60.

This mutually aligns the through hole 211 of the sealant 210 and the penetration hole 61 of the metal plate 60 to penetrate the unit cell 100 through the through hole 211 and the penetration hole 61, thereby helping the unit cell 100 to be easily inserted into the through hole 211 and the penetration hole 61.

The bonding material 220 is applied around the edge of the through hole 211 so that the sealant 210 may be certainly fixed to the metal plate 60 and/or the unit cell 100. The bonding material 220 may be preferably formed of a ceramic bond. The bonding material 220 formed of a ceramic bond is applied between the through hole 211 and the outer circumferential surface of the unit cell 100, thereby securing the bonded state of the sealant 210 while sealing the spaced gap between the through hole 211 and the unit cell 100.

As described above, the bonding material 220 may be preferably formed of alumina-based, zirconia-based ceramic bond, and the like and the ceramic bond has porosity in terms of characteristics. The bonding material 220 formed of a porous material seals and bonds between the sealant 210 and the outer circumferential surface of the unit cell 100 and may provide slight contractibility and expansibility to the bonding material 220 according to the external conditions such as a temperature difference, and the like, according to the operation of the solid oxide fuel cell. The contractibility and expansibility prevent the separation or crack of the bonding material 220 to secure the durability of the solid oxide fuel cell assembly. It is revealed beforehand that the bonding material 220 is not limited to the ceramic bond and may use a bond of various materials.

In addition, the bonding material 220 may also be applied between the edge of the sealant 210 and an inner circumferential surface of the housing 10 (see FIG. 1) so as to help the bonding of the sealant 210.

In addition to this, the sealing material 230 according to the preferred embodiment of the present invention arranges a glass-based sealing material 230 on the bonding material 220. The sealing material 230 is certainly covered on the bonding material 220 so that the bonding material 220 applied in a ring shape along the outer circumferential surface of the unit cell 100 is not exposed to the external environment.

The solid oxide fuel cell assembly according to the prior art may provide the sealing effect by finishing between the metal plate and the unit cell with only the glass-based sealing material and in this case, the sealant is melted under the high temperature to flow down along the outer circumferential surface of the unit cell. On the other hand, according to the preferred embodiment of the present invention, even when the sealing material 230 is changed to a melted state under the high temperature, it is possible to prevent the sealant from flowing down due to the bonding material 220 and/or the sealant 210.

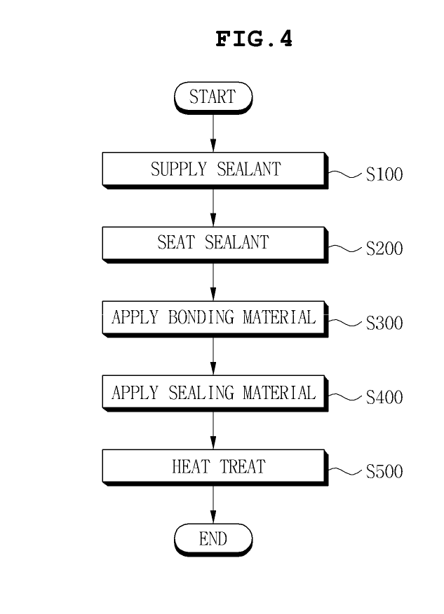

FIG. 4 is a flow chart illustrating a method for forming the seal 200 illustrated in FIG. 3 in the solid oxide fuel cell assembly, in more detail, the bonded part between the metal plate 60 and the unit cell 100.

The preferred embodiment of the present invention includes supplying the sealant 210 formed of a mica material (S100) (see FIG. 3). The sealant 210 is formed of a mica material easily processed and the plurality of through holes 211 are punched so as to help the stack of the unit cells 100.

Preferably, the through holes 211 of the sealant 210 are the same as the number and arrangement position of penetration holes 61 of the metal plate 60, thereby inserting the unit cells 100 into the through holes 211 and the penetration holes 61. Selectively, the diameter of the through hole 211 is designed to be smaller than that of the penetration hole 61 to minimize the exposure of the metal plate 60 to the outside.

Next, the preferred embodiment of the present invention includes seating the sealant 210 on the metal plate 60. As described above, in order to dispose the unit cell 100 in the housing, the sealant 210 needs to be disposed on the metal plate 60 that is highly likely to contact fuel. Each component includes the through hole 211 and the penetration hole 61 and aligns the through hole 211 and the penetration hole 61 in parallel to help the insertion of the unit cell 100.

The preferred embodiment of the present invention includes applying the bonding material 220 (S300).

The bonding material 220 is applied around the spaced gap that is formed between the through hole 211 of the sealant 210 and the outer circumferential surface of the unit cell 100. The bonding material 220 secures the coupling between the metal plate 60 and the sealant 210 and between the unit cell 100 and the sealant 210. As the bonding material 220, a ceramic-based bond formed of a porous material may be preferably used.

Finally, the preferred embodiment of the present invention includes applying the sealing material 230 (S400).

The sealing material 230 is applied between the outer circumferential surface of the unit cell 100 and the upper surface of the sealant 210 enough to completely cover the outer surface of the cured bonding material 220.

In addition, the preferred embodiment of the present invention includes heat treating the seal 200 (S500) and may promote the bonding and stabilization between respective components by the heat treatment.

In the heat treating (S500), the separate heat treatment may be performed at 100° C. to 200° C. so as to affect the bonding material 220.

Further, the separate heat treatment may be additionally performed at 700° C. to 900° C. so as to affect the sealing material 230.

As set forth above, according to the preferred embodiments of the present invention, the present invention can provide the solid oxide fuel cell in which the sealed part between the unit cell to be inserted into the penetration hole of the metal plate and the penetration hole is arranged.

According to the preferred embodiments of the present invention, the sealant formed of a mica material can be disposed on the metal plate to prevent the metal plate from being oxidized, thereby improving the durability.

Further, according to the preferred embodiment of the present invention, it is possible to prevent the sealing material from being lost under the high-temperature power generation temperature, thereby preventing the fuel and air from contacting with each other.

In addition, the preferred embodiments of the present invention, the man hour and the manufacturing costs can be remarkably reduced by merely disposing the sealant having the same shape as the metal plate in the solid oxide fuel cell assembly and applying the bonding material and the sealing material around the edge of the through hole of the sealant without the separate change in design.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell assembly, comprising:
one or more unit cell;
a metal plate provided with one or more penetration hole through which the unit cell penetrates; and
a seal configured of a sealant, a bonding material, and a sealing material and sealing a spaced gap between an outer circumferential surface of the unit cell and a penetration hole of the metal plate.

2. The solid oxide fuel cell assembly as set forth in claim 1, wherein the sealant has a plate shape having a through hole corresponding to the metal plate.

3. The solid oxide fuel cell assembly as set forth in claim 1, wherein the bonding material is applied between an edge of the through hole of the sealant and an outer circumferential surface of the unit cell.

4. The solid oxide fuel cell assembly as set forth in claim 1, wherein the sealing material is applied to cover an outer circumferential surface of the bonding material.

5. The solid oxide fuel cell assembly as set forth in claim 4, wherein the sealing material is applied between an upper surface of the sealant and the outer circumferential surface of the unit cell.

6. The solid oxide fuel cell assembly as set forth in claim 1, wherein the sealant is formed of a mica material.

7. The solid oxide fuel cell assembly as set forth in claim 1, wherein the bonding material is formed of a porous ceramic-based bond.

8. The solid oxide fuel cell assembly as set forth in claim 1, wherein the sealing material is formed of a glass-based material.

9. The solid oxide fuel cell assembly as set forth in claim 1, wherein the sealant has an O-ring shape and is arranged along the outer circumferential surface of the unit cell and an edge of the penetration hole of the metal plate.

10. The solid oxide fuel cell assembly as set forth in claim 2, wherein a diameter of the through hole is smaller than that of the penetration hole.

11. A method for forming a solid oxide fuel cell assembly as set forth in any one of claims 1 to 10, the method comprising:
supplying a sealant;
seating the sealant on a metal plate so as to prevent fuel and air from contacting with each other;
applying a bonding material to a through hole of the sealant; and
applying the sealing material on the bonding material.

12. The method as set forth in claim 11, further comprising:
heat treating.

13. The method as set forth in claim 12, wherein in the heat treating, heat treatment is performed at 100° C. to 200° C. so as to affect the bonding material.

14. The method as set forth in claim 12, wherein in the heat treating, heat treatment is performed at 700° C. to 900° C. so as to affect the sealing material.

15. The method as set forth in claim 11, wherein the sealant is formed of a mica material.

16. The method as set forth in claim 11, wherein the bonding material is formed of a porous ceramic-based bond.

17. The method as set forth in claim 11, wherein the sealant has a plate shape having a through hole corresponding to the metal plate.

18. The method as set forth in claim 11, wherein the bonding material is applied between an edge of the through hole of the sealant and an outer circumferential surface of the unit cell.

19. The method as set forth in claim 11, wherein the sealing material is applied to cover an outer circumferential surface of the bonding material.

20. The method as set forth in claim 11, wherein the sealing material is applied between an upper surface of the sealant and the outer circumferential surface of the unit cell.
